(19) United States
(12) Patent Application Publication
(10) Pub. No.: US 2005/0234580 A1
(43) Pub. Date: Oct. 20, 2005

(54) Automated replenishment notification systems and methods

(75) Inventor: Robert W. Roldan, San Jose, CA (US)

Correspondence Address: Siemens Corporation;Intellectual Property Department, 170 Wood Avenue South, Iselin, NJ, 08830, US

(73) Assignee: Siemens Medical Solutions USA, INC.

(21) Appl. No.: 10/825,817

(22) Filed: Apr. 16, 2004

(51) Int. Cl. G06F 19/00

(52) U.S. Cl. 700/106; 700/112

(57) ABSTRACT

Automated replenishment notification is provided for manufacturing pieces. The removal of manufacturing pieces is sensed. Notifications, such as orders, are automatically generated and provided to suppliers in response to a sensed removal. Automatic notification allows for a minimum or maximum demand pull system to be implemented without user involvement to place an order or send an order. Order fulfillment may also be tracked. Where a time period passes without replenishment, a reminder or follow up message is automatically generated.

### BACKGROUND

The present invention relates to automated inventory tracking. In particular, automated inventory notification for manufacturing pieces is provided.

Manufacturing facilities include storage areas for storing manufacturing pieces. Manufacturing pieces are stored as individually stacked items, separately packaged items, a plurality of items provided in a box or other methods. Manufacturing pieces are typically placed on racks, such as conveyors or shelving units. As products are assembled in the manufacturing facility, manufacturing pieces are removed from the storage racks. If that one type of manufacturing piece is unavailable, the manufacturing facility may be unable to produce a product, reducing productivity.

To avoid downtime, manufacturing pieces are preordered. For example, the number of products manufactured is tracked and the various pieces or components for each product are preordered based on expected and actual number of products made. Manufacturing pieces are replenished by placing an order. In response to the order, the pieces are provided whether needed or not at a current time. However, a tracking and ordering process in such a push system may be inaccurate. Costs associated with storing as well as having unneeded pieces are undesired.

In a minimum or maximum demand pull system, a product is ordered based on immediate need. By tracking usage of a product, the order is requested to ship and be provided within a specific time frame. However, mistakes in tracking manufacturing pieces, identifying need and identifying an associated date of the need may result in downtime or decreases in productivity.

Automated inventory systems for facilitating replenishment of goods in manufacturing facilities have been provided. Sensors detect the presence of desired inventory items. An inventory processor then facilitates restocking of those items where the stock level has fallen below a predetermined level. However, a user monitors the restocking and provides control.

### SUMMARY

By way of introduction, the preferred embodiments described below include methods and systems for automated replenishment notification for manufacturing pieces. The removal of manufacturing pieces is sensed. Notifications, such as an order, are automatically generated and provided to suppliers in response to a sensed removal. Automatic notification allows for a minimum or maximum demand pull system to be implemented without user involvement to place an order or send an order. Order fulfillment may also be tracked. Where a time period passes without replenishment, a reminder or follow up message is automatically generated.

In a first aspect, a method is provided for automated replenishment notification for manufacturing pieces. Manufacturing pieces are positioned on a gravity fed rack. Removal of the manufacturing pieces is sensed. An electronic notification is provided in response to sensing a removal.

In a second aspect, a system is provided for automated replenishment notification for manufacturing pieces. A sensor is adjacent to a gravity fed rack. This sensor is positioned to sense a presence of a manufacturing piece on the gravity fed rack. A processor connects with the sensor. The processor is operable to generate a notification in response to a signal from the sensor indicating a lack of the manufacturing piece and is operable to communicate the notification to another processor.

In a third aspect, a method for automated replenishment notification is provided for manufacturing pieces. Two different types of manufacturing pieces are positioned on two different racks. The removal of any of the manufacturing pieces from the two racks is automatically sensed. Orders for the different types of manufacturing pieces are electronically communicated independent of the removal of another type of manufacturing piece.

In a fourth aspect, a system is provided for automated replenishment notification for manufacturing pieces. A plurality of sensors is provided adjacent to a plurality of racks. Each sensor is positioned to sense the presence of a manufacturing piece on a respective one of the racks. A processor connects with the plurality of sensors. The processor is operable to generate orders independently for each of the racks in response to the sensors indicating a lack of manufacturing pieces on the racks. The processor is also operable to communicate the orders to at least another processor.

In a fifth aspect, a method is provided for automated replenishment notification for manufacturing pieces. Manufacturing pieces are positioned on a rack. Removal of the manufacturing pieces is sensed. An electronic notification is generated in response to the sensing. A lack of replacement of manufacturing pieces after a time period is sensed. A further electronic notification is provided in response to the lack of replacement.

In a sixth aspect, a system is provided for automated replenishment notification for manufacturing pieces. A sensor is adjacent to the rack. The sensor is positioned to sense a presence of manufacturing pieces on the rack. A processor connects with the sensor. The processor is operable to generate a notification in response to a signal from the sensor indicating a lack of the manufacturing piece, operable to communicate the notification to another processor, operable to sense a lack of replacement of the manufacturing piece after a time period, and operable to generate an additional notification in response to the lack of replacement.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for automated replenishment notification;

FIG. 2 is a top view of one embodiment of a gravity fed rack; and

FIG. 3 is a flow chart diagram of one embodiment of a method for automated replenishment notification.

### DETAILED DESCRIPTION OF THE DRAWINGS AND PRESENTLY PREFERRED EMBODIMENTS

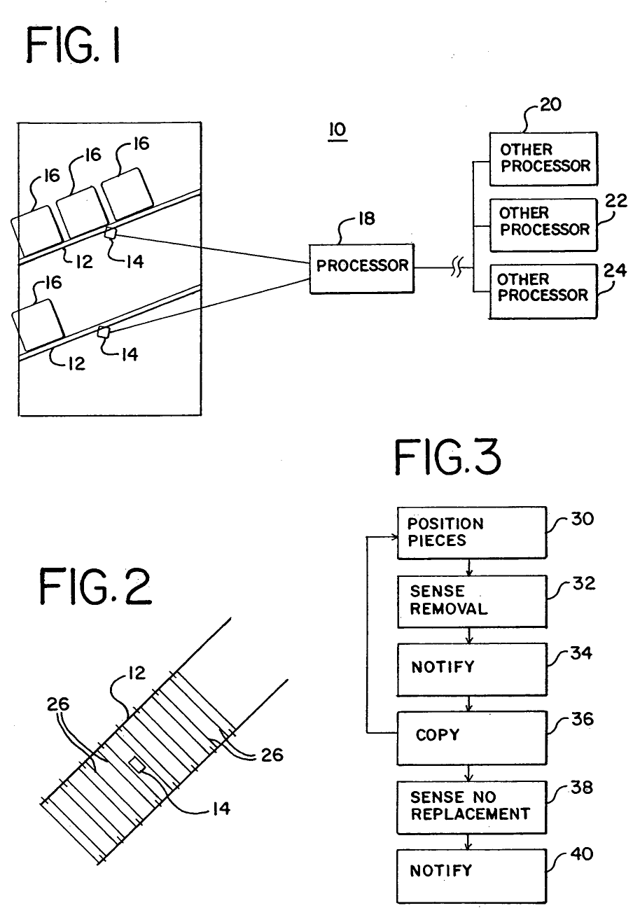

FIG. 1 shows a system 10 for automated replenishment notification for manufacturing pieces. The system 10 is located in a manufacturing facility, such as adjacent to an assembly line or in a warehouse. The system 10 includes a plurality of racks 12, a plurality of sensors 14, and a processor 18. The racks 12 support none, one or more manufacturing pieces 16. The processor 18 communicates with one or more additional processors 20, 22 and/or 24. Additional, different or fewer components may be provided, such as providing only one rack 12, only one sensor 14, or additional processors.

The racks 12 are gravity fed racks in one embodiment. For example and as shown in FIG. 1, the racks 12 are mounted at an angle relative to the horizon so that manufacturing pieces 16 positioned on top of the racks 12 move through force of gravity to a front of the rack 12. FIG. 2 shows one embodiment of the rack 12 for gravity feeding as a gravity flow span track. A plurality of parallel rollers 26 are provided to allow migration of the manufacturing pieces to a lower position. In one embodiment, only gravity is used for moving the manufacturing pieces. Alternatively, one or more of the rollers 26, a belt, an arm or other source of force is applied to the manufacturing pieces 16 for movement. In another embodiment of a gravity fed rack 12, a slick surface, such as a Teflon surface, is provided to allow the manufacturing pieces 16 to move by the force of gravity. In yet another embodiment, a flat surface is provided so that wheels on the manufacturing pieces or kanbans holding a plurality of manufacturing pieces may move under the force of gravity. In yet other alternative embodiments, the racks 12 are in a horizontal position or other position not relying on gravity for movement of pieces. The manufacturing pieces are either expected to remain stationary on the rack 12 or are moved under other sources of power, such as by a conveyer belt or other mechanical movement device.

The manufacturing pieces 16 may be kanbans full of a plurality of pieces. For example, a box or other container holds multiple pieces and is positioned on the rack. As a kanban is emptied, it is removed from the rack. Removal of the container from the rack or removal of pieces without removal of the kanban may activate the sensor 14.

The sensors 14 are snap action switches, spring activated mechanical switches, electronic eyes, infrared sensors, micro photoelectric sensors, weight sensors or other now known or later developed sensors. One or more sensors 14 are positioned adjacent to each rack 12. Each sensor 14 is positioned to sense the presence of a manufacturing piece 16 on one or more of the racks 12. Sensors to sense different manufacturing pieces on a same rack at the same time may be provided. In one embodiment shown in FIG. 2, the sensor 14 is positioned between two rollers 26. An arm or switching element of the sensor 14 extends above the rollers. With a manufacturing piece 16 resting on the arm, the switch is in one position and with the removal of the manufacturing piece, the switch is in a different position. Alternatively, an electronic eye, infrared or other optically based sensor is positioned above, below or beside the rack 12.

The position of the sensor 14 along the rack 12 is selected to sense the presence of the manufacturing piece. For a gravity fed rack, the sensor 14 is positioned along the rack 12 above a lowest position in one embodiment, such as shown in FIG. 1. As a result, the sensor 14 senses when some of the manufacturing pieces are removed, such as shown by the lower rack 12 of FIG. 1, and senses when the rack is relatively full as shown in the upper rack 12 of FIG. 1. One or more manufacturing pieces 16 remain in a lower portion of the rack below the sensor 14 for use during manufacture, yet the sensor 14 is activated to generate an order. Alternatively, the sensor 14 is positioned to detect removal of a last manufacturing piece or kanban of pieces, such as being at the lowest portion of a gravity fed track.

The sensor 14 communicates with the processor 18 through a wire, but wireless communication may be used. For example, an active wire or USB input/output board and associated USB cabling is provided to connect the sensors 14 to the processor 18. Serial or parallel communication may alternatively be used. In one embodiment, individual cables are used, but a bus structure may be used in other embodiments.

The processor 18 is a general processor, control processor, application specific integrated circuit, server, digital components, analog components, combinations thereof and/or other now known or later developed processors. In one embodiment, the processor 18 is a personal computer with a USB digital input and output board and associated software. Software on the processor 18 receives signal from the sensors 14 for generating notifications. The processor 18 also includes a modem, Ethernet card, network card, output bus, output signal line or other now known or later developed structures for communicating notification to another processor. Software on the processor 18 allows for a user interface, communication route, removable storage input or other source of assigning particular manufacturer pieces or types of pieces to particular racks 12 and associated sensors 14. The communication protocol for notifications associated with the rack 12 and sensor 14 are also input, such as providing an e-mail address, telephone number, communication protocol or other information.

The processor 18 is operable to generate a notification in response to a signal from one or more of the sensors 14 indicating a lack of manufacturing piece. For example, the processor 18 communicates an order or warning. In one embodiment, the notification is an e-mail, but notifications pursuant to private standards, other network structures or protocols may be used.

Notifications are generated independently for each of the racks 12 or for different groups of racks 12 in response to the sensors 14 indicating a lack of manufacturing pieces. For example, a different manufacturing piece is provided on each of the two racks 12 shown in FIG. 1. Where one type of manufacturing piece shown in the lower rack is removed from the rack 12, the sensor 14 senses a lack of the manufacturing pieces at a particular position along the rack 12. In response, an e-mail order is generated for that manufacturing piece and specific to a particular supplier. The lack or presence of different types of manufacturing pieces on the upper rack 12 may not alter the ordering or notification generated using the sensor 14 on the lower rack. Alternatively, multiple racks 12 include the same type of manufacturing pieces 16. A notification may be generated only when both sensors 14 on the two different racks 12 indicate a lack of manufacturing pieces. A dual sensor 14 on a same rack may be used for providing a countdown or priority level of notification and associated orders.

The processor 18 communicates with one or more other processors 20, 22 and 24. The other processors 20, 22 or 24 are personal computers, servers or other processors used within the same manufacturing facility or remote from the manufacturing facility. For example, the processor 20 is a supplier's server or personal computer on a network connected through the Internet, through a telephone link or other route to the processor 18. When a lack of manufacturing pieces is sensed, an e-mail order is automatically placed with the supplier without user activation of sending the order. Alternatively, the notification merely informs the supplier that an order may be pending or requests that the supplier contact the manufacturer to discuss an order. As another example, the processor 22 is a personal computer or other computer operated by a purchaser of the manufacturer for monitoring orders, controlling inventory or other activities. As yet another example, the processor 24 is a computer accessed by a manufacturing supervisor. The manufacturing supervisor can then plan manufacturing activities, such as which products to be made in a particular line, based on available inventory as communicated automatically by the processor 18. The other processors 20, 22, 24 are connected through the Internet, an intranet, a direct connection, a modem connection, a wireless connection, combinations thereof or other now known or later developed communication structures and associated protocols. Other processors and associated individuals may be notified, such as buyers and accounts payable.

The processor 18 generates the notification a delayed time period after the sensor 14 indicates a lack or removal of a manufacturing piece. The delayed time period is seconds, minutes, hours or days. The delay period allows for stuck manufacturing pieces 16 or otherwise hung up pieces in a gravity feed system to work their way to the proper positioning. Alternatively, an immediate ordering or notification is provided. In yet another embodiment, an initial notification is provided to a warehouse supervisor, manufacturing supervisor or other personnel so that the gravity feed system or other arrangement of manufacturing pieces on any rack 12 may be checked or verified. If after the delayed time period, a lack of manufacturing pieces is still detected, an order or other notification is generated as discussed above.

Another time period may be triggered from sensing a lack or removal of manufacturing items or from when a notification was previously generated. A continued lack of manufacturing items after hours, days, weeks, or other time periods may more likely result in a productivity decrease. As a result, one or more additional notifications are generated after this longer time period. The additional notifications are provided to any of the individuals or processors discussed above, such as a reminder order communicated to a supplier and copied to a purchaser and a manufacturing supervisor. The reminder order may indicate that different manufacturing products should be scheduled, that a supplier should be contacted to verify delivery or that a shipper should be contacted to verify delivery. By sensing a lack of replacement of manufacturing pieces, manufacturing shutdowns are more likely avoided.

In addition to electronically communicated notifications, a visual display may be generated as an optional embodiment. For example, a display of which racks have a lack of manufacturing pieces is generated. An LED board, computer monitor or other graphical displays may be used. Lights or other indicators at each rack 12 may also be used.

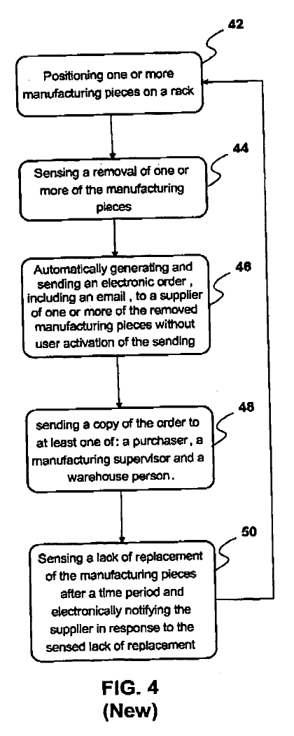

FIG. 3 shows one embodiment of a method for automated replenishment notification for manufacturing pieces. The method is implemented using the system shown in FIG. 1 or a different system. Different, additional or fewer acts may be provided than shown in FIG. 3 in the same or different order.

In act 30, manufacturing pieces are positioned on a rack. For example, manufacturing pieces are positioned on a gravity fed rack. In one embodiment, a plurality of manufacturing pieces of a same type is positioned in different kanbans. Each kanban contains a plurality of the manufacturing pieces. The kanbans or individual manufacturing pieces to sequentially feed to a lower position on the gravity fed rack. Alternatively, kanbans or individually manufacturing pieces are positioned on a horizontal rack, such as a shelf Different types of manufacturing pieces are positioned on different racks. Alternatively, different types of manufacturing pieces are positioned on a same rack in a known order with a known size. Given the size of the manufacturing pieces and the order, the sensor or multiple sensors may detect different manufacturing pieces on the same rack.

In act 32, removal of manufacturing pieces is sensed. For example, the removal of a kanban is sensed. Alternatively, the removal of an individual manufacturing pieces sensed whether removed from a kanban (e.g., weight sensor or optical sensor position above the kanban) or without a kanban. The removal of the manufacturing pieces is sensed by sensing when a position along a gravity feed rack or positioned within a rack is free of manufacturing pieces. For example, a mechanical switch is used to sense at a position higher than a lowest position on the gravity feed rack. As a result, the removal of some, most, all or any number of manufacturing pieces is sensed. By sensing removal of some manufacturing pieces before all manufacturing pieces have been removed, an order may more likely be placed in sufficient time to avoid delays in production due to lack of inventory. Alternatively or additionally, the removal of the manufacturing piece from the lowest position on a gravity fed rack is sensed. The same or different sensing is performed for different racks and associated different types of manufacturing pieces.

In act 34, an electronic notification is generated in response to sensing removal of the manufacturing piece. For example, an e-mail is sent to a supplier of the manufacturing pieces without user activation of the sending, generation or notification. The e-mail is an automatic order for more manufacturing pieces. The notification may be delayed to allow for correction of placement of manufacturing pieces, such as electronically notifying after sensing a lack of replacement of the manufacturing piece within a time period, such as a minute or hour. In alternative embodiments, the notification is electronically sent to other people or processors than a supplier, such as any of the personnel disclosed herein.

The notification is electronically communicated to different suppliers or individuals for different types of manufacturing pieces. For example, a different order is provided to different suppliers for different types of manufacturing pieces. The orders are electronically communicated independent of the inventory of the other types of manufacturing pieces. Rather than generating a list of pieces for order, a more immediate electronic communication allows for more likely rapid order fulfillment for different types of manufacturing pieces. For example, different emails are sent at different times to different suppliers for different types of manufacturing pieces without user activation of the sending. These e-mails or orders are sent independently in response to the independent sensing of the removal or lack of manufacturing pieces.

In act 36, a copy of the order or other notification is sent to other individuals or processors. For example, a copy is sent to a purchaser, a manufacturing supervisor, a warehouse person or an accounting department. The copy is used for monitoring performance by the supplier, fulfillment of the order, payment of the order, planning production or other purposes. In alternative embodiments, a copy is not sent, is sent after a delay or is sent prior to electronic notification to the supplier.

Where the electronic order is fulfilled within a particular time period, the process repeats to act 30 of positioning the manufacturing pieces. In a further embodiment, the presence of manufacturing pieces is continually monitored in act 38 to sense no replacement of the manufacturing pieces. For example, for a time period after the removal of manufacturing pieces is sensed or after the electronic notification, a lack of replacement of the manufacturing pieces is sensed in act 38. The time period used may be set by a user or may be calculated based on past performance. For example, the number of pieces used during a time period and the average or longest time period for resupply once an order has been placed are used to calculate a desired time period. The time period may be associated with maximizing avoidance of lack of inventory, such as within a week of an expected removal of the last manufacturing piece.

In act 40, an electronic notification is provided in response to the sensed lack of replacement. For example, a reminder is communicated to a processor of the supplier or other individual discussed herein. The manufacturing supervisor may alternatively or additionally be electronically notified. The manufacturing supervisor may then plan production around any lack of inventory. A purchaser may be notified for contacting the supplier to determine a status of an order.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A method for automated replenishment notification for manufacturing pieces, the method comprising:
(a) positioning one or more manufacturing pieces on a rack;
(b) sensing a removal of one or more of the manufacturing pieces;
(c) automatically generating and sending an electronic order to a supplier of one or more of the removed manufacturing pieces in response to (b).

2. The method of claim 1 wherein (a) comprises positioning a plurality of containers each having a plurality of manufacturing pieces and wherein (b) comprises sensing removal of a container.

3. The method of claim 1 wherein (b) comprises sensing when a position along the rack is free of manufacturing pieces.

4. The method of claim 1 wherein (b) comprises sensing with a mechanical switch.

5. The method of claim 1 wherein (c) comprises sending an e-mail to a supplier of the manufacturing pieces in response to (b) without user activation of the sending.

6. The method of claim 1 wherein (c)
further comprises:
(d) sending a copy of the order to at least one of: a purchaser, a manufacturing supervisor and a warehouse person.

7. The method of claim 1 further comprising:
(d) sensing a lack of replacement of the manufacturing pieces after a time period from one of (b) and (c); and
(e) electronically notifying in response to (d).

8. The method of claim 7 wherein (e) comprises electronically notifying at least one of: a supplier and a manufacturing supervisor.

9. The method of claim 1 wherein (c) is performed in response to (b) after sensing a lack of a replacement manufacturing piece within a time period.

10. The method of claim 1 wherein (a) comprises positioning a plurality of the manufacturing pieces to sequentially feed to a lower position on the rack and wherein (b) comprises sensing at a position higher than the lower position on the rack.

11. A system for automated replenishment notification for manufacturing pieces, the system comprising:
a gravity feed rack;
a sensor adjacent to the gravity feed rack, the sensor positioned to sense a presence of a manufacturing piece on the gravity feed rack; and
a first processor connected with the sensor, the first processor operable to generate an electronic order in response to a signal from the sensor indicating a lack of the manufacturing piece and operable to communicate the order to a second processor.

12. The system of claim 11 wherein the gravity feed rack comprises a plurality of rollers, the sensor positioned between two of the plurality of rollers.

13. The system of claim 11 wherein the sensor is positioned to sense at a location along the gravity feed rack such that the lack of the manufacturing piece is sensed while another manufacturing piece is present below the location.

14. The system of claim 11 wherein the sensor is a spring activated mechanical switch.

15. The system of claim 11 wherein the first processor is operable to generate and send an e-mail order.

16. The system of claim 11 wherein the first processor is operable to sense a lack of replacement of the manufacturing piece after a time period in response to the sensor and is operable to generate a notification in response to the lack of replacement.

17. A method for automated replenishment notification for manufacturing pieces, the method comprising;
(a) positioning a first type of manufacturing pieces on a first rack;
(b) positioning a second type of manufacturing pieces on a second rack;
(c) automatic sensing for removal of manufacturing pieces from the first and second racks;
(d) electronically communicating a first order to a supplier for the fist type of manufacturing pieces where removal of the first type of manufacturing pieces is sensed; and
(e) electronically communicating a second order to a supplier for the second type of manufacturing pieces where removal of the second type of manufacturing pieces is sensed;
wherein the first order is independent of removal of the second type of manufacturing pieces and the second order is independent of removal of the first type of manufacturing pieces.

18. The method of claim 17 wherein (d) and (e) comprise sending first and second e-mails, respectively, to first and second suppliers, respectively, the first supplier different than the second supplier, (d) and (e) performed without user activation of the sending.

19. The method of claim 17 further comprising:
(f) sensing a lack of replacement of at least one of the first and second type of manufacturing pieces after a time period; and
(g) electronically communicating a reminder.

20. A system for automated replenishment notification for manufacturing pieces, the system comprising:
a plurality of racks;
a plurality of sensors adjacent to the plurality of racks, each sensor positioned to sense a presence of a manufacturing piece on a respective one of the plurality of racks; and
a processor connected with the plurality of sensors, the processor operable to generate orders independently for each of the racks in response to the sensors indicating a lack of manufacturing pieces on the racks, the processor operable to communicate the orders to a supplier.

21. A method for automated replenishment notification for manufacturing pieces, the method comprising:
(a) positioning one or more manufacturing pieces on a rack;
(b) sensing a removal of one or more of the manufacturing pieces;
(c) automatically generating and sending an electronic order to a supplier of one or more of the removed manufacturing pieces in response to (b);
(d) sensing a lack of replacement of the manufacturing pieces after a time period from one of (b) and (c); and
(e) electronically notifying in response to (d).

22. The method of claim 21 wherein (c) comprises sending an e-mail to a supplier of the manufacturing pieces in response to (b) without user activation of the sending.

23. The method of claim 21 wherein (c)
further comprises:
(f) sending a copy of the order to at least one of: a purchaser, a manufacturing supervisor and a warehouse person.

24. The method of claim 21 wherein (e) comprises electronically notifying at least one of: a supplier and a manufacturing supervisor.

25. A system for automated replenishment notification for manufacturing pieces, the system comprising:
a rack;
a sensor adjacent to the rack, the sensor positioned to sense a presence of a manufacturing piece on the rack; and
a processor connected with the sensor, the processor operable to generate an electronic order in response to a signal from the sensor indicating a lack of the manufacturing piece, operable to communicate the electronic order to another processor, operable to sense a lack of replacement of the manufacturing piece after a time period in response to the sensor and operable to generate a notification in response to the lack of replacement.

26. The system of claim 25 wherein the rack comprises a gravity feed rack, the electronic order is communicated to a supplier with a first copy to a purchaser and the notification is a reminder to the supplier and a second copy to the purchaser.

27. The method of claim 1, wherein (b) and (c) are tracked.

28. The method of claim 1, and further comprising:
(d) sending an electronic notification after a time period passes after (c), wherein the electronic notification comprises a reminder.

29. The method of claim 1, wherein said sending comprises sending by use of wireless communication.

30. The method of claim 1, and further comprising:
(e) setting a priority level for the electronic notification, wherein said priority level is based at least in part on said time period.

31. The system of claim 11, wherein said system, comprises one of: a demand pull system.
